(19) United States
(12) Patent Application Publication
(10) Pub. No.: US 2015/0264540 A1
(43) Pub. Date: Sep. 17, 2015

(54) Method of Escalating Delivery of Undelivered Messages

(71) Applicant: TigerText, Inc., Santa Monica, CA (US)

(72) Inventors: Brad Brooks, Beverly Hills, CA (US); Sumeet Bhatia, Los Angeles, CA (US); Sean Whiteley, Pacific Palisades, CA (US)

(21) Appl. No.: 14/659,512

(22) Filed: Mar. 16, 2015

Related U.S. Application Data
(60) Provisional application No. 61/953,144, filed on Mar. 14, 2014.
(60) Provisional application No. 61/953,135, filed on Mar. 14, 2014.

(51) Int. Cl. H04W 4/14; H04L 12/58

(52) U.S. Cl. CPC H04W 4/14; H04L 51/30; H04L 51/36

(57) ABSTRACT

A system for sending an alert message having a processor and memory, the processor configured to perform the steps of receiving a message from a sender, sending, via a data channel of a wireless network, the message to a recipient device, determining the message has not been delivered to the recipient via the data channel, and sending, via an SMS message over a control channel of the wireless network, the alert message to the recipient device, wherein the alert message indicates at least the presence of the message.

This application claims the benefit of U.S. Patent App. Ser. No. 61/953,135 filed on Mar. 14, 2014 and U.S. Patent App. Ser. No. 61/953,144, filed on Mar. 14, 2014, which are hereby incorporated by reference in their entirety.

### BACKGROUND

U.S. patent application Ser. Nos. 13/063,763 and 13/046,862, filed by the applicant hereof and hereby incorporated by reference, describe a system for ephemeral messaging, whereby individuals can have conversations that “self-destruct” or disappear after a predetermined period of time. As discussed in more detail therein, these messages are different from traditional electronic mail or text messaging systems, which are stored persistently.

Messages and ephemeral messages described in the above-referenced patent applications, are traditionally delivered over the Internet. Mobile devices, such as smart phones, can connect to traditional cellular telephone networks for services such as telephone calls or Simple Message System (SMS) messages and can connect to the Internet via a variety of networks. In some situations due to networking issues, Internet connectivity may fail while telephone and SMS connectivity continue to function normally.

When the primary mechanism of message delivery is cut off, it is useful to have a system that will deliver alerts about the existence of new messages over SMS, telephone calls or other out-of-band communications.

There are many instances with mobile phone data networks where they become unavailable or unable to receive information. Certain cellular bands/networks are unable to receive data when an individual is making a phone call. However, even during this time this person is able to receive a second phone call with call waiting or receive an SMS because this information travels over the primary cellular connection.

As an example, if an individual is on a phone call they could still be notified of a critical message with this alternate routing. If an application is able to detect that messages are being delayed and not delivered but the messages are of a critical nature the application can select an alternative route of message delivery such as phone call or SMS.

### SUMMARY OF THE INVENTION

A system for sending an alert message having a processor and memory, the processor configured to perform the steps of receiving a message from a sender, sending, via a data channel of a wireless network, the message to a recipient device, determining the message has not been delivered to the recipient via the data channel, and sending, via an SMS message over a control channel of the wireless network, the alert message to the recipient device, wherein the alert message indicates at least the presence of the message.

### DESCRIPTION OF DRAWINGS

FIG. 1 is a flow diagram in accordance with one aspect of the present invention.

FIG. 2 is a screen shot of an alert message in accordance with one aspect of the present invention.

### DETAILED DESCRIPTION OF THE INVENTION

In an Internet-based message system, delivery notification can be used so that the sender is told when his or her message has been “delivered” to the recipient. When the message flag is set to “delivered”, then the message is present on the intended recipient device, and the user may proceed to access the content. The mechanisms of marking a message as delivered depend on whether the message payload is embedded in the push notification or if the push notification is a trigger for the recipient to retrieve the message.

In one aspect of the invention of the present disclosure, when the message is delivered via the push message payload, the push notification system can alert the sending application that the message has successfully been delivered to the device. However, if Internet connectivity is unavailable to the device, then the push notification will not successfully reach the mobile device, and the delivery escalation process shall be enabled as described below.

In another aspect of the invention, the push notification is used as a trigger to alert an application running on the recipient device to contact the sending application and retrieve any pending messages for delivery. This may require the application have Internet communications capability at the time that the push trigger notification is received. With mobile devices, there are times when Internet connectivity is intermittent. In such a case there could be an instance where the push notification trigger has been received but the application that resides on the recipient mobile device is unable to connect to the sending application to retrieve any pending messages for delivery. In this case, the delivery escalation process may be enabled as described below.

If a predetermined or user-defined period of time, for example 120 seconds, has transpired and the “delivered” flag has not been set for a particular message, the application may check to see if the intended recipient for that message has a cellular telephone number associated with that user's account with the messaging service. If such a cellular telephone number is found in the user's account, the system may send a message to that telephone number via SMS and/or via a phone call. In accordance with one aspect of the invention, such SMS alert messages are not delivered unless the sender or recipient has subscribed to a premium service tier with the system. In accordance with one aspect of the invention, an entire organization, such as a business, can subscribe to the premium service tier for all of its senders.

In an ephemeral messaging system, other considerations may be made to determine when to escalate messages. Such considerations could include: a message will expire prior to its escalation, a message is about to expire and therefore an escalation is made to alert the recipient that the message will no longer be available after a few minutes.

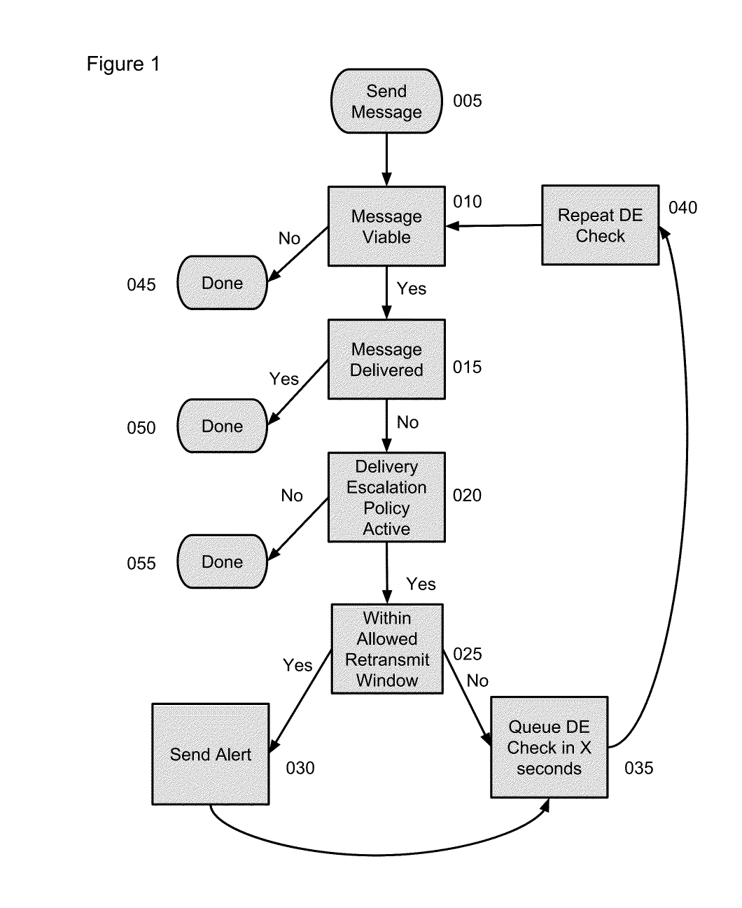

In FIG. 1 Step 005, an application may receive a message from a user addressed to a recipient. In Step 010, the application may determine whether the message is viable. The message may not be viable if it has been deleted, expired or viewed more than permitted. If the message is not viable (No, Step 010), then in Step 045 the process finishes. If the message is viable (Yes, Step 010), then in Step 015, the application may determine whether the message has been successfully delivered to the recipient. If the message has been delivered (Yes, Step 015), then in Step 050 the process finishes.

If the message has not been delivered (No, Step 015), then in Step 020, the application determines via the delivery escalation policy check whether it will escalate the message using an alternative delivery path, if available and at what time because the message is at this time still undelivered. If the delivery escalation policy is not active (No, Step 020), then in Step 055 the process finishes. If the delivery escalation policy is active (Yes, Step 020), then in Step 025, the application determines whether the application may send delivery escalation (“alert”) messages to the recipient. In accordance with one aspect of the invention, to avoid having the recipient bombarded with alert messages, the user and/or the system can set a frequency or time limit during which the recipient will not receive a second alert message if it has already received an alert message during that time frame. In accordance with one aspect of the present invention, that time period can be twenty (20) seconds, a user or recipient can stop and/or restart alert messages by sending an alert message to a telephone number associated with the message system. In another aspect, the system can refrain from sending the alert message based on a time of day, e.g., a user or administrator can deem certain times of day “off limits” for sending alert messages. In another aspect, the system can refrain from sending the alert message based a number of messages sent to recipient, e.g., an hourly, daily, or weekly threshold.

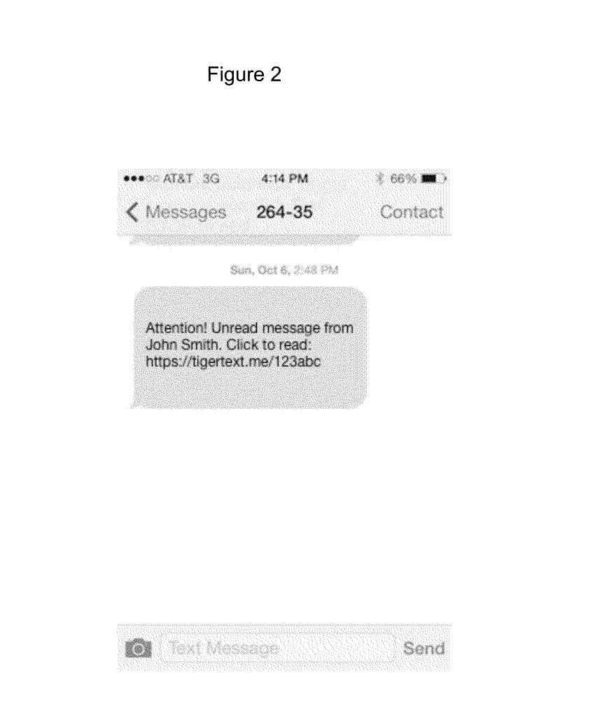

An alert message according to one non-limiting example, is shown in FIG. 2. The alert message may include one or more of the following: an indicator that a message exists for the recipient; the name or other information identifying the sender; and a hyperlink to the message.

Once in Step 025, if the message is not within a predetermined acceptable retransmit time window or recipient has elected to stop receipt of alert messages, (No, Step 025), then in Step 035 the application determines re-transmission was not allowed at the time of the check, and the message is placed into a queue and moves to Step 040 to repeat the delivery escalation process at Step 010.

If the message is within a predetermined acceptable retransmit time window and recipient hasn't elected to stop receipt of alert messages (Yes, Step 025), then in Step 030 the application attempts to contact the recipient via the best delivery escalation method possible by checking the list of available or preferred contact methods for that recipient (e.g., telephone numbers) and sending the delivery escalation alert message.

What is claimed is:

1. A system for sending an alert message comprising a processor and memory, the processor configured to perform the steps of:
a. receiving a message from a sender;
b. sending, via a data channel of a wireless network, the message to a recipient device;
c. determining the message has not been delivered to the recipient via the data channel; and
d. sending, via an SMS message over a control channel of the wireless network, the alert message to the recipient device, wherein the alert message indicates at least the presence of the message.

2. The system for sending an alert message of claim 1, wherein step d. comprises:
d1. determining the message is marked for delivery escalation;
d2. determining the message is eligible for transmission; and
d3. sending the alert message.

3. The system for sending an alert message of claim 2, wherein in step d2, the message is eligible for transmission when it has not been deleted, has not been viewed more than a predetermined number of times, and has not been viewed beyond a predetermined time duration.

4. The system for sending an alert message of claim 1, wherein in step c., the system determines the message has not been delivered upon one of an expiration of a predetermined delivery time and upon receipt of a delivery failure notification.

5. The system for sending an alert message of claim 1, wherein the alert message comprises the message.

6. The system for sending an alert message of claim 1, wherein the alert message comprises a hyperlink to the message.

7. The system for sending an alert message of claim 1, wherein the alert message comprises an identifier of a sender of the message.

8. The system for sending an alert message of claim 1, wherein step 1.d. further comprises:
d. refraining from sending the alert message based on one or more of a recipient request, time of day, a number of messages sent to the recipient, and frequency of previous alert messages sent to the recipient.

9. The system for sending an alert message of claim 1, wherein the wireless network is one of a cellular network, wifi network, and bluetooth.

10. A system for sending an alert message comprising a processor and memory, the processor configured to perform the steps of:
a. receiving a message from a sender;
b. sending, via a data channel of a wireless network, the message to a recipient device;
c. determining the message has not been delivered to the recipient via the data channel; and
d. sending, via a phone call over the wireless network, the alert message to the recipient device, wherein the alert message is an audio message indicating at least the presence of the message.
